(19) United States
(12) Patent Application Publication
(10) Pub. No.: US 2008/0281664 A1
(43) Pub. Date: Nov. 13, 2008

(54) System and method for managing use and availability of equipment

(76) Inventor: David Matthew Campbell, Upper Marlboro, MD (US)

Correspondence Address: MARTIN & FERRARO, LLP, 1557 LAKE O'PINES STREET, NE, HARTVILLE, OH, 44632, US

(21) Appl. No.: 12/151,473

(22) Filed: May 7, 2008

Related U.S. Application Data
(60) Provisional application No. 60/928,022, filed on May 7, 2007.

(51) Int. Cl. G06Q 10/00

(52) U.S. Cl. 705/8; 705/1; 705/34

(57) ABSTRACT

A system and method is disclosed for managing use and availability of equipment on a jobsite. The system includes a group of equipment units being available to be reserved and/or used by pre-approved users. A control panel is provided on each of the units of equipment to facilitate operation of the corresponding unit associated therewith. At least a first indicator is included with each of the control panels for displaying an indication whether the corresponding unit is reserved. At least one input receiving device is included with each of the control panels for inputting authorization input provided by a pre-approved user. At least one memory device is included with each of the control panels. A processor is included with each of the control panels adapted to verify the authorization input through comparison of a list of authorized inputs stored in the memory device with the authorization input. Once the authorization input is verified, the system authorizes the pre-approved user to reserve the corresponding unit.

The present application claims the benefit of U.S. Provisional Application No. 60/928,022 filed May 7, 2007; all of which is incorporated herein by reference.

### BACKGROUND OF THE INVENTION

1. Field of the Invention

The present invention is generally related to a system for managing use and availability of motorized equipment on a jobsite. More particularly, the present invention is related to a system of providing motorized equipment to a jobsite, insuring that such equipment is efficiently utilized, and allocating costs based on the utilization of such equipment. More specifically, the present invention is related to a system for providing users of motorized equipment with an economic incentive for maximizing use thereof.

2. Description of the Prior Art

In certain circumstances, groups of motorized equipment units such as, but not limited to, scissor lifts, forklifts, loaders, earth movers, air compressors, generators, and welding units used at jobsites in, for example, construction, industrial, mining, and warehouse settings are leased. In these circumstances, the users pay for use of such units of motorized equipment during the time period of conventional leases whether the equipment is actually being utilized. Furthermore, the expense associated with such units of motorized equipment is not limited to the lease thereof. The users expend resources arranging for the provision of such units of motorized equipment to the jobsites. As such, the users of such units of motorized equipment expend time and money arranging for the lease and transportation of such motorized equipment to the jobsites, but may not make efficient use thereof during the duration of the lease.

Additionally, because leasing such units of motorized equipment is often expensive, potential users forego such motorized equipment for relatively small jobs. If these small jobs take only short periods of time to complete, the expense associated with leasing such units of motorized equipment may not justify the expense. Instead, these potential users have traditionally manually completed these small jobs.

Therefore, there is a need for a system for providing resources such as units of motorized equipment to jobsites, and insuring the efficient use thereof. Such a system can provide access to the units of motorized equipment on the jobsites, and allocate costs to the users thereof based on whether the units have been reserved and/or used. In doing so, the system can provide the users with an economic incentive for maximizing use of the motorized equipment, and also provides the users access to the motorized equipment for various periods of time.

### SUMMARY OF THE INVENTION

The present invention in one preferred embodiment contemplates a method for managing use and availability of units of equipment on a jobsite including providing the units of equipment to the jobsite; placing a control panel on each of the units of equipment; making the units of equipment available on a first-come, first-serve basis to a group of users pre-approved to reserve and/or use the units of equipment; requiring a user from the group of pre-approved users to provide authorization input to the control panel to reserve and/or use one unit of the units of equipment; comparing the authorization input to a list of authorized inputs; authorizing, if the authorization input corresponds to one of the authorized inputs, the user to reserve the one unit of the units of equipment for a specified period of time; and permitting the user of a reserved unit to actuate the reserved unit, and to use the reserved unit during the specified period of time.

The present invention in a further preferred embodiment contemplates a system for managing use and availability of equipment on a jobsite including a group of equipment units, each unit of the group of equipment units available to be reserved and/or used by pre-approved users; a control panel provided on each unit of the group of equipment units, each of the control panels facilitating operation of the corresponding unit associated therewith; at least a first indicator included with each of the control panels, each of the first indicators displaying an indication whether the corresponding unit is reserved; at least one input receiving device included with each of the control panels, each of the at least one input receiving devices for inputting authorization input provided by one of the pre-approved users; at least one memory device included with each of the control panels, each of the memory devices including a list of authorized inputs; a processor included with each of the control panels adapted to verify the authorization input through comparison with the list of authorized inputs; a remote data center including a database containing the list of authorized inputs, the remote data center communicating with each of the control panels to periodically update each of the memory devices with an updated version of the list of authorized inputs; and each of the at least one input receiving devices being operable, upon verification of the authorization input, to permit the one of the authorized users to reserve the corresponding unit.

The present invention in another preferred embodiment contemplates a method for managing use and availability of units of equipment on a jobsite including approving a group of users to reserve and/or use the units of equipment on the jobsite; providing each user of the group of the users with an authorization input facilitating reservation of the units of equipment on a first-come, first-serve basis; requiring each user of the group of the users to provide the authorization input to a control panel provided on each of the units of equipment to reserve and/or use each of the units of equipment; verifying the authenticity of the authorization input entered by the user into the control panel of one of the units of equipment; authorizing, if the authorization input is verified, the user to reserve the one of the units of equipment for a specified period of time; and permitting a reserved unit to be actuated by the user and used by the user during the specified period of time.

It is understood that both the foregoing general description and the following detailed description are exemplary and exemplary only, and are not restrictive of the invention as claimed.

### BRIEF DESCRIPTION OF THE DRAWINGS

The accompanying drawings, which are incorporated in and constitute a part of the specification, illustrate preferred embodiments of the invention. Together with the description, they serve to explain the objects, advantages and principles of the invention. In the drawings:

FIG. 1 is a flow chart depicting one embodiment of the system according to the present invention for managing use and availability of units of equipment on a jobsite.

FIG. 2 is a flow chart further depicting a step of FIG. 1 for facilitating operation of the units of equipment.

FIG. 3 is a perspective view of a scissor lift.

FIG. 4 is a schematic representation of components used in the system of FIG. 1.

### DETAILED DESCRIPTION OF THE PREFERRED EMBODIMENT

The following description is intended to be representative only and not limiting and many variations can be anticipated according to these teachings. Reference will now be made in detail to the preferred embodiments of this invention, examples of which are illustrated in the accompanying drawings.

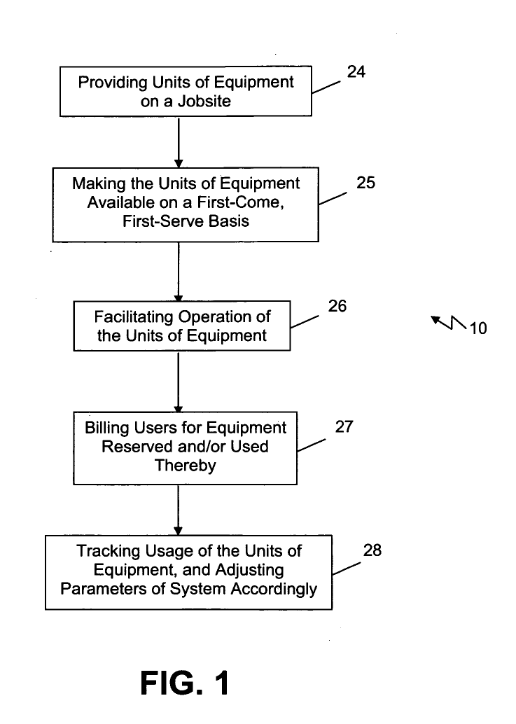

FIG. 1 shows a system according to one preferred embodiment of the present invention which is generally indicated by the numeral 10. System 10 is for managing use and availability of resources such as a group of motorized equipment units used at jobsites in, for example, construction, industrial, mining, and warehouse settings. In doing so, system 10 can provide access to potential users to the units of motorized equipment provided by a provider on a jobsite. The potential users can reserve and/or use the units of motorized equipment on a first-come, first-serve basis, and system 10 can allocate costs associated with providing such units of motorized equipment to the users thereof based on a specified period of time the units have been reserved and/or used. Accordingly, while system 10 provides the users access to the units of motorized equipment, system 10 also provides the users with an economic incentive to maximize the use thereof.

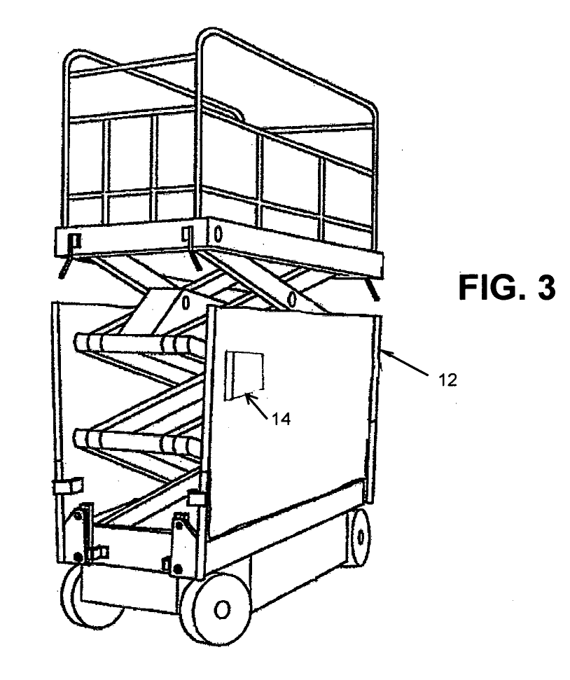

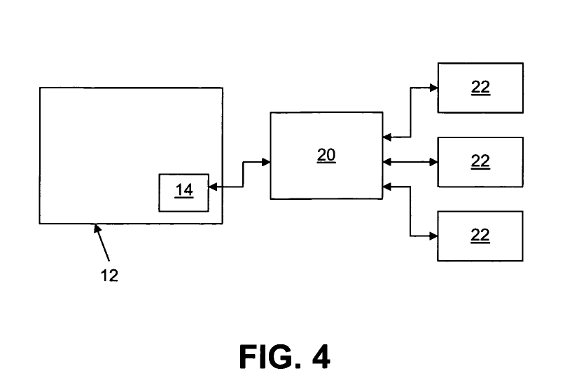

A control panel 14, as shown in FIGS. 3 and 4, is provided for facilitating use of system 10. Control panel 14 is provided on the units of equipment provided to the jobsite for which system 10 is used for managing the use and availability thereof. Control panel 14 controls operation of the units of equipment, and is adapted for inputting, outputting, displaying, and processing information regarding system 10. Using control panel 14, the units of equipment can be reserved and/or used by a user. To that end, control panel 14 can include first and second input receiving devices, a display, a memory device, a processor, and a locating device such as GPS (global positioning system) unit. Although the first and second input receiving devices, the display, the memory device, the processor, and the locating device are not shown, the provision of such devices, after a reading of the below-discussed uses thereof, is within understanding of one of ordinary skill in the art.

The first and second input receiving devices, the display, the memory device, the processor, and the locating device can be components of control panel 14, separate components hardwired to control panel 14, or separate components wirelessly connected to control panel 14. Furthermore, devices serving as the first and second input receiving devices can include, for example, keypads, touch screens, RFID receivers, swipe card readers, bar code readers, etc. As discussed below, the user can enter input information using the first or second input receiving devices, and, if necessary, a corresponding input device (not shown) to facilitate the units of equipment to be reserved and/or used.

Control panel 14, depending on whether the units of equipment are powered by an electric motor or an internal combustion engine, can be interconnected to the on/off switch (not shown) or the ignition switch (not shown), respectively, of the equipment. As such, control panel 14 can serve to control actuation of the electric motor or the internal combustion engine powering the equipment by interrupting the supply of electricity to the electric motor or the supply of electricity and/or fuel to the internal combustion engine.

FIG. 3 shows, for example, a scissor lift 12 for which system 10 can be used. Scissor lift 12 is representative of the units of equipment that system 10 can be used for managing the use and availability thereof. However, system 10 should not be limited to use in association with scissor lift 12. System 10 could also be used in association with other motorized equipment including, for example, forklifts, loaders, earth movers, air compressors, generators, and welding units. Control panel 14 is provided on scissor lift 12 to facilitate operation thereof. Control panel 14 is connected to the ignition system of scissor lift 12 to control actuation thereof, and is adapted for inputting, outputting, displaying, and processing information regarding system 10. As discussed below, once authorized by control panel 14, scissor lift 12 can be reserved and/or used by the user.

Control panel 14 allows information to be inputted and correlated with other information. For example, the input information can include authorization input that is used to gain access to scissor lift 12. The authorization input can be used, for example, to identify the user or the user's employer, and/or identify a defined period of time or number of instances that scissor lift 12 can be reserved and/or used. Accordingly, users possessing the authorization input are pre-approved to reserve and/or use scissor lift 12.

The memory device of control panel 14 can be used to record usage information regarding scissor lift 12. In doing so, the memory device can, for example, record the period of time that the user has reserved and/or used scissor lift 12. The processor of control panel 14 can then correlate the usage information to the input information (i.e., identifying the user or the user's employer, and/or identifying a defined period of time or number of instances that scissor lift 12 can be reserved and/or used). Such input and correlated information is used to facilitate allocation of costs to users of the equipment.

As shown in FIG. 4, the input and correlated information can ultimately be transferred from control panel 14 to a remotely located data center or hub 20. Data center 20 can be a computer configured to receive the input and correlated information, manipulate such information, and communicate with offsite computers 22. Accordingly, data center 20 can communicate with control panel 14, can be programmed with software to manipulate the input and correlated information, and can communicate with other computers such as offsite computers 22 to allow users to access information regarding system 10.

During use of system 10, as shown in FIG. 1, a provider provides the units of equipment (e.g., scissor lift 12) to a jobsite at step 24. The provider makes the units of equipment available to potential users on a first-come, first-serve basis at step 25. At step 26, system 10 facilitates authorized users to operate the units of equipment. Thereafter, the authorized users can be billed for the units of the equipment that have been reserved and/or used at step 27; and, at step 28, the usage of the units of equipment can be tracked, and the parameters of system 10 can be adjusted accordingly.

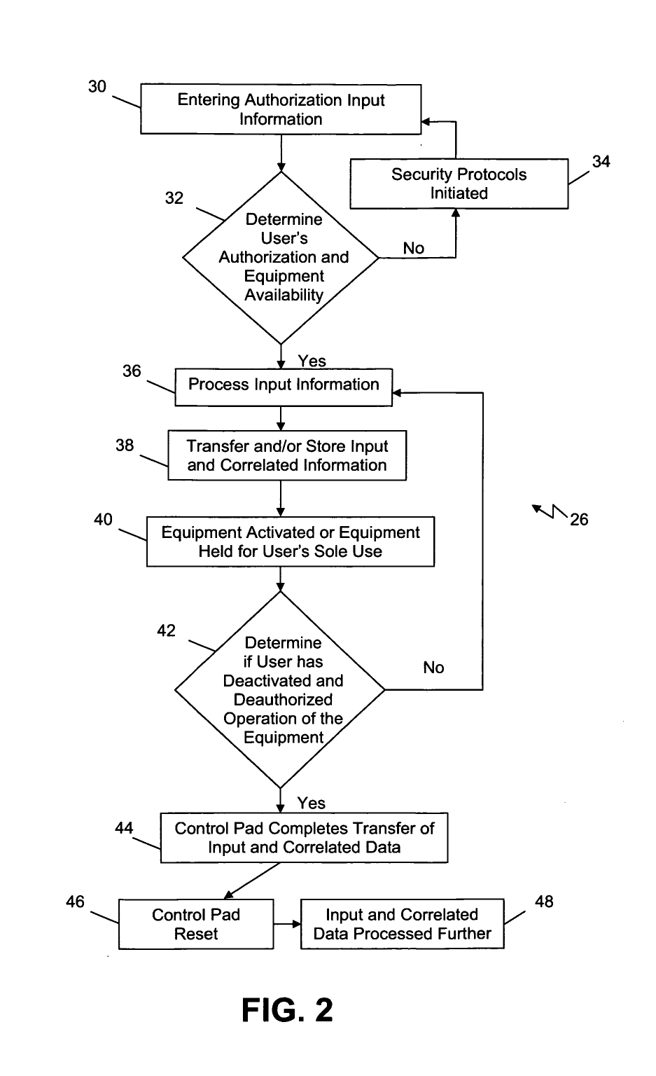

As shown in FIG. 2, step 26 is broken into sub-steps 30-48. To facilitate operation of scissor lift 12, at shown in FIG. 2, sub-step 30 initially prompts a user to enter the input information such as the authorization input. The authorization input can be code identifying the user or the user's employer, and/or identifying a defined period of time or number of instances that scissor lift 12 can be reserved and/or used. Either way, the authorization input is entered by pre-approved users possessing such input using the first input receiving device of control panel 14.

To input the authorization input to control panel 14, the user can use the input device such as an RFID chip, a magnetic stripe, or a bar code embedded with the code to provide the authorization input to the corresponding first input receiving device. The RFID chip, the magnetic stripe, and the bar code could, for example, be provided on a key card or key fob. Alternatively, if the first input receiving device is a keypad or a touch screen, the user can manually enter the code used as the authorization input. If the authorization input does not correspond to account information and/or reservation information, such additional input information can also be entered at sub-step 30. Ultimately, the authorization input and additional input information, such as account information and/or reservation information, and any correlated information is transferred to data center 20.

Thereafter, using the processor of control panel 14, the authorization input is compared to a list of authorized inputs and the availability of scissor lift 12 is determined at sub-step 32 to verify that scissor lift 12 can be reserved and/or used by the user. The list of authorized inputs can be provided by data center 20, and can be stored in a database of a memory device at data center 20 or the memory device of control panel 14. The list of authorized inputs can be updated in the memory device of control panel 14 and/or the authorized input compared thereto when control panel 14 is communicating with data center 20. When using the database stored in the memory device at data center 20, for example, the authorized input can be communicated to data center 20 from control panel 14 (using the below-discussed methods of communication) before the input and correlated information is transferred at step 38. Furthermore, the list of authorized inputs can be updated when, as discussed below, at steps 38 and 44 the input and correlated information is transferred to data center 20. If at sub-step 32 the processor associated with control panel 14 determines that the user is not authorized (e.g., incorrect authorization input has been entered) to operate scissor lift 12 and/or that scissor lift 12 is unavailable, the processor can initiate security protocols at sub-step 34. The security protocols can serve to lock out use of scissor lift 12 temporarily until the lock out is overridden. Once the lock out of scissor lift 12 is overridden, system 10 again begins at sub-step 30. If the processor associated with control panel 14 verifies the authorization input, the user is authorized to reserve and/or use scissor lift 12, and the input information is processed further at sub-step 36.

During processing at sub-step 36, the input information identifying the authorized user or the authorized user's employer, and/or identifying a defined period of time or number of instances that scissor lift 12 can be reserved and/or used can be correlated, for example, with other information. As discussed above, the memory device of control panel 14 can be used to record the usage information regarding scissor lift 12. As such, the input information can be correlated with the usage information recorded by the memory device. For example, the input information can be correlated with information such as the date and time that the authorized user entered the input information, the time period that scissor lift 12 has been authorized to be reserved and/or used, and the time period that scissor lift 12 has actually been reserved and/or used. Furthermore, if control panel 14 includes the locating device, the input information can also be correlated with information regarding the location of scissor lift 12.

At sub-step 38, the input and correlated information can be transferred to data center 20, and/or stored for later transfer to data center 20. The input and correlated information could be transferred continuously or periodically during operation of scissor lift 12. For example, the input and correlated information can be transferred to data center 20 using wireless connectivity thereto. For example, point-to-point technology such as Qualcomm's Global TRACS devices could be used between control panel 14 and data center 20. If the input and correlated information is transferred periodically, the information could be stored by the memory device of control panel 14 during the time intervals between transfers. Thereafter, the input and correlated information could be transferred wirelessly, or the memory device of control panel 14 could be hardwired to data center 20 or an intervening storage device (not shown) to facilitate transfer of the input and correlated information to data center 20.

At sub-step 40, scissor lift 12 can be reserved and/or used by the authorized user for a specified period of time. The specified period of time corresponds to the time up until the user has deactivated and deauthorized use of scissor lift 12 at sub-step 42, or, as discussed below, a reservation for an open block of time on a particular date. As such, with verified authorization input at sub-step 32, scissor lift 12 can be actuated or held for the authorized user's sole use during the specified period of time. Once actuated, the authorized user can use scissor lift 12. Alternatively, control panel 14 can lock out use of scissor lift 12 for only the authorized user. In doing so, control panel 14 reserves scissor lift 12 for the authorized user's sole use during the specified period of time and prevents other users from actuating scissor lift 12. When locked out, control panel 14 can require the input information to be reentered by the authorized user to permit actuation thereof. Therefore, to reserve and/or use scissor lift 12, the authorized user may be required to input the authorization input to the first input receiving device a first time at sub-step 30, and then to input the authorization input to the first input receiving device a second time at sub-step 40.

In reserving scissor lift 12, the display of control panel 14 can be used. In one preferred embodiment, the display can be a structural component included with control panel 14 that is, for example, raised to indicate that scissor lift 12 is reserved. In another preferred embodiment, the display can include two (2) indicator lights or illuminated elements (not shown). After the user has been authorized, the first indicator light can indicate that scissor lift 12 is reserved, and the second indicator light can indicate that scissor lift 12 is ready for use. For example, the first indicator light can be alighted continuously if scissor lift 12 has been reserved, and, accordingly, serve as an indication to a potential user that scissor lift 12 is not currently available for use. Therefore, when the first indicator light is alighted, only the authorized user can use scissor lift 12. For example, if, at sub-step 40, use of scissor lift 12 has been locked out by control panel 14 (and, hence, the first indicator light is alighted), the input information may be required to be reentered by the authorized user to permit actuation of scissor lift 12. Thereafter, the second indicator light would, for example, be alighted, and the authorized user can actuate scissor lift 12 to begin use thereof.

In another preferred embodiment, the display can be a display screen forming computer-generated characters or symbols thereon. As such, the display screen could be the touch screen used as the input receiving device. The display screen, for example, can read “reserved” and/or “ready for use” instead of or in addition to utilizing the first and second indicator lights, respectively. The display screen could also identify the authorized user or the authorized user's employer who has reserved scissor lift 12, indicate billing rates, indicate data and time information detailing the time period that scissor lift 12 has been reserved and/or used, and indicate, if the authorization input defines the period of time or number of instances that scissor lift 12 can be reserved and/or used, the remaining period of time or number of instances.

The display screen could also display scheduling information to allow a potential user to reserve and/or use scissor lift 12 at a future date and time. In one preferred embodiment, even if the scissor lift 12 is currently reserved for another user, the display screen could display blocks of time on particular dates that scissor lift 12 is open to be reserved and/or used. Thereafter, using the first or second input receiving devices, the potential user can make a reservation for an open block of time on a particular date for use of scissor lift 12. For example, if the first or second input receiving devices are keypads or touch screens, the potential user can enter input information facilitating reservation of the open block of time on the particular date. Once reserved, control panel 14 will lock out use of scissor lift 12 for only the authorized user during that period of time.

At sub-step 42, the processor associated with control panel 14 determines whether the authorized user has deactivated and deauthorized use of scissor lift 12. If use of scissor lift 12 has not been deactivated and deauthorized, scissor lift 12 can continue to be actuated and/or held for the authorized user's sole use during the specified period of time. However, if scissor lift 12 has been deactivated and deauthorized, control panel 14 completes transfer of the input and correlated information to data center 20 at sub-step 44, and is reset at sub-step 46. To deauthorize use of scissor lift 12, control panel 14 can simply require that scissor lift 12 be deactivated, include a button (not shown) that can be actuated, or require the input information to be reentered.

Once transfer of the input and correlated information at sub-step 44 is completed, data center 20 can further process such information at sub-step 48. As discussed above, the correlated information can be usage information correlated with the input information identifying the authorized user or the authorized user's employer, and/or identifying a defined period of time or number of instances that scissor lift 12 can be reserved and/or used. Furthermore, data center 20 can be programmed with accounting and billing software. At step 27, as shown in FIG. 1, the accounting and billing software can be used to allocate the costs associated with the use of the equipment to the authorized user. For example, with the information provided by control panel 14, the authorized user can be billed for the period of time that scissor lift 12 was reserved and/or used. That is, the authorized user can be billed for the time which scissor lift 12 was actuated, the time scissor lift 12 was held for the authorized user's sole use, or both.

Billing rates for the units of equipment under system 10 can vary depending on a number of factors. Different users, for example, can negotiate different billing rates, and, hence, can be grouped according to such billing rates. As discussed above, the authorized user can be billed for the period of time that the unit of equipment (e.g., scissor lift 12) was reserved and/or used thereby. Furthermore, the authorized user can be billed for use over the time of the reservation, or can be credited for use under the time of the reservation.

The billing rate for the period of time can also vary depending on the period of time. For example, the billing rate can be greater for shorter lengths of time than for longer lengths of time. However, even though the billing rate can be greater for shorter lengths of time using system 10, the expense to the authorized user could potentially be less than for conventional leases of the units of equipment. With conventional leases, users pay for use of the units of equipment during the time period thereof whether the equipment is actually being utilized. However, under system 10, a user can be billed for the period of time that the unit of equipment is used. Hence, if the user requires only intermittent use of the unit of equipment over a particular time period, the expense to the user could be less than a conventional lease over that particular time period.

Control panel 14 also can be adapted for measuring the amount of energy used by the authorized user. The authorized user can be billed for such energy usage, and also billed if the unit of equipment is not recharged and/or refueled after being deactivated and deauthorized. If control panel 14 is provided with the locating device, then the authorized user can be billed when, for example, scissor lift 12 is not returned to a specified location on the jobsite. The authorized user can also be billed if scissor lift 12 is removed from a specified location on the jobsite.

As discussed above, at step 28, system 10 also can be used in tracking usage of the units of equipment on the jobsite, and adjusting parameters of the system accordingly. In doing so, the data center 20 can also be programmed with software to correlate usage information of the units of equipment with other information to develop usage statistics therefor. For example, the software of data center 20 can be used to determine if the usage of the units of equipment necessitates maintenance thereof, and can schedule maintenance for the units of equipment accordingly.

Furthermore, at step 28, the software of data center 20 also can be used to adjust the number of units of equipment provided to the jobsite. For example, to determine an appropriate number of units of equipment to provide to the jobsite at step 24, the provider will initially evaluate available manpower and work being done on the jobsite. Using system 10, the usage of the units of equipment reserved can be tracked and correlated to the available manpower and the work being performed on the jobsite. Thereafter, at step 28, the appropriate number of units of equipment can be adjusted upwardly or downwardly by the provider. As such, the number of the units of equipment provided by the provider to the jobsite can be optimized.

Data center 20 can also, as discussed above, be configured to communicate with other computers such as offsite computers 22 using, for example, the Internet. As such, information can be transferred back and forth between data center 20 and other computers, which in certain preferred embodiments include offsite computers 22. For example, using an interface communicating with data center 20, the user using offsite computers 22 can access available information from data center 20 related to use of scissor lift 12. Furthermore, data center 20 and offsite computers 22 can be programmed to allow users to determine the availability of a particular scissor lift 12. If control panel 14 is provided with the locating device, the location of a particular scissor lift 12 could also be determined. Accordingly, once the availability and location of a particular scissor lift 12 is ascertained, the user can locate that scissor lift 12 so that it can be reserved and/or used.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for managing use and availability of units of equipment on a jobsite, comprising:
providing the units of equipment to the jobsite;
placing a control panel on each of the units of equipment;
making the units of equipment available on a first-come, first-serve basis to a group of users pre-approved to reserve and/or use the units of equipment;
requiring a user from the group of pre-approved users to provide authorization input to the control panel to reserve and/or use one unit of the units of equipment;
comparing the authorization input to a list of authorized inputs;
authorizing, if the authorization input corresponds one of the authorized inputs, the user to reserve the one unit of the units of equipment for a specified period of time; and
permitting the user of a reserved unit to actuate the reserved unit, and to use the reserved unit during the specified period of time.

2. The method of claim 1, further comprising initially evaluating the available manpower and work being performed on the jobsite, so as to provide an appropriate number of the units of equipment is to the jobsite.

3. The method of claim 2, further comprising determining a number of the units of equipment reserved, and tracking usage of each of the units of equipment reserved.

4. The method of claim 3, further comprising correlating the available manpower and the work being performed on the jobsite to the number of the units of equipment reserved and the usage of each of the units of equipment reserved, and adjusting the appropriate number of the units of equipment to be provided to the jobsite.

5. The method of claim 1, further comprising prohibiting unauthorized use of the reserved unit via the control panel by interrupting actuation of the unit.

6. The method of claim 1, further comprising prohibiting a second user to reserve and/or use the reserved unit when reserved by the user.

7. The method of claim 1, further comprising requiring the user to provide the specified period of time to the control panel.

8. The method of claim 1, further comprising dividing the group of users into at least a first group and a second group, wherein the first sub-group and the second sub-group have a billing rate different from one another.

9. The method of claim 1, further comprising billing the user for the specified period of time that the reserved unit is reserved.

10. The method of claim 9, further comprising setting a billing rate for reserving the reserved unit according to the length of the specified period of time.

11. The method of claim 10, wherein the billing rate is greater for shorter lengths of time than for longer lengths of time.

12. The method of claim 1, further comprising tracking usage of the reserved unit via the control panel, and billing the user for use over the specified period of time.

13. The method of claim 1, further comprising tracking usage of the reserved unit via the control panel, and billing the user is credited for use under the specified period of time.

14. The method of claim 1, further comprising tracking usage via a remote data center in communication with each of the control panels of the units of equipment provided to the jobsite, and scheduling maintenance when usage of each of the units of equipment surpasses a specified threshold.

15. The method of claim 1, further comprising measuring energy usage by the reserved unit, and billing the user for the energy usage.

16. The method of claim 1, further comprising determining whether the reserved unit requires recharging and/or refueling, and billing the user if the reserved unit is not recharged and/or refueled.

17. The method of claim 1, further comprising providing an interface accessible by the user over the Internet, and permitting the user to access billing information through the interface.

18. The method of claim 1, further comprising providing the control panel with a locating device communicating with a remote data center, and determining at the remote data center the location of each of the units of equipment using the locating device.

19. The method of claim 18, further comprising providing an interface communicating with the remote data center over the Internet, the interface permitting the user to locate a specific one of the units of equipment.

20. The method of claim 18, further comprising determining a billing rate for reserving and using the one of the units of equipment according to whether the reserved unit is returned to a specified location.

21. The method of claim 18, further comprising determining a billing rate for reserving and using the one of the units of equipment according to whether the reserved unit is removed from a specified location.

22. The method of claim 1, further comprising processing the comparison of the authorization input provided by the user and the list of authorized users via the processor of the control panel.

23. The method of claim 22, wherein, when comparing the authorization input to the list of authorized inputs, utilizing a database containing the list of authorized inputs stored in a memory device provided at the control panel.

24. The method of claim 22, wherein, when comparing the authorization input to the list of authorized inputs, communicating via the control panel with a remote data center, and utilizing a database containing the list of authorized inputs stored in a memory device provided at the remote data center.

25. A system for managing use and availability of equipment on a jobsite, comprising:
a group of equipment units, each unit of said group of equipment units available to be reserved and/or used by pre-approved users;
a control panel provided on each unit of said group of equipment units, each of said control panels facilitating operation of the corresponding unit associated therewith;
at least a first indicator included with each of said control panels, each of said first indicators displaying an indication whether the corresponding unit is reserved;
at least one input receiving device included with each of said control panels, each of said at least one input receiving devices for inputting authorization input provided by one of the pre-approved users;
at least one memory device included with each of said control panels, each of said memory device including a list of authorized inputs;
a processor included with each of said control panels adapted to verify the authorization input through comparison with the list of authorized inputs;
a remote data center including a database containing the list of authorized inputs, the remote data center communicating with each of said control panels to periodically update each of said memory devices with an updated version of the list of authorized inputs; and
each of said at least one input receiving devices being operable, upon verification of the authorization input, to permit the one of the authorized users to reserve the corresponding unit.

26. The system of claim 25, further comprising an actuation mechanism associated with each of said control panels, each of said actuation mechanisms starting the corresponding unit upon actuation thereof by the one of the authorized users.

27. The system of claim 25, wherein said at least one memory device also records usage of the corresponding unit to bill the one of the authorized users for the usage.

28. The system of claim 25, wherein said at least one input receiving device is one of a keypad, a touch screen, an RFID receiver, a swipe card reader, and a bar code reader.

29. The system of claim 25, wherein the authorization input is a code embedded in one of an RFID chip, a magnetic stripe, and a bar code.

30. The system of claim 25, wherein said first indicator included with each of said control panels is one of being a component of each of said control panels, a component hardwired to each of said control panels, and a component wirelessly connected to each of said control panels.

31. The system of claim 25, wherein said at least one input receiving device included with each of said control panels is one of being a component of each of said control panels, a component hardwired to each of said control panels, and a component wirelessly connected to each of said control panels.

32. The system of claim 25, wherein said remote data center communicates with each of said control panels by at least one of a hardwire, a wireless connection, and an intervening storage device.

33. The system of claim 25, wherein said first indicator is one of an illuminated element and a raised structural component.

34. The system of claim 25, further comprising a display included with each of said control panels, each of said displays displaying one of billing rates and scheduling information for the corresponding unit.

35. The system of claim 25, further comprising an interface accessible by the pre-approved users over the Internet, said interface permitting the pre-approved users to access billing information through the interface.

36. The system of claim 25, further comprising a locating device associated with each of said control panels, each of said locating devices communicating with said remote data center to determine the location of the corresponding unit.

37. The system of claim 36, further comprising an interface communicating with said remote data center over the Internet, said interface permitting the pre-approved users to locate each unit of said group of equipment units.

38. A method for managing use and availability of units of equipment on a jobsite, comprising:
approving a group of users to reserve and/or use the units of equipment on the jobsite;
providing each user of the group of the users with an authorization input facilitating reservation of the units of equipment on a first-come, first-serve basis;
requiring each user of the group of the users to provide the authorization input to a control panel provided on each of the units of equipment to reserve and/or use each of the units of equipment;
verifying the authenticity of the authorization input entered by the user into the control panel of one of the units of equipment;
authorizing, if the authorization input is verified, the user to reserve the one of the units of equipment for a specified period of time; and
permitting a reserved unit to be actuated by the user and used by the user during the specified period of time.
